(19) United States
(12) Patent Application Publication
(10) Pub. No.: US 2007/0260748 A1
(43) Pub. Date: Nov. 8, 2007

(54) METHOD AND APPARATUS TO REDUCE THE SIZE OF OBJECTS TRANSMITTED OVER A NETWORK

(76) Inventor: Jerry Lee Talkington, San Francisco, CA (US)

Correspondence Address: SCHWEGMAN, LUNDBERG & WOESSNER, P.A., P.O. BOX 2938, MINNEAPOLIS, MN, 55402, US

(21) Appl. No.: 11/381,953

(22) Filed: May 5, 2006

(51) Int. Cl. G06F 15/16

(52) U.S. Cl. 709/246

(57) ABSTRACT

An Internet device, such as an accelerator, to speed up the delivery of content in a dynamic fashion, the device parsing code to identify a block of code that is not an embedded object, performing a hash function on the parsed block of code to provide a source URL and to determine whether the parsed block of code has already been cached, and to cache the block of code if not already cached, and to send to a client a compressed version of the block of code along with the source URL.

### FIELD

Embodiments of the present invention relate to network communications, and more particularly, to devices to speed up the delivery of content from a server to a client over a network.

### BACKGROUND

An accelerator is a device to speed up the process by which content, such as a Web page, is sent from a server to a client, such as a browser, over a network or the Internet. An accelerator is sometimes referred to as a network appliance. Often, an accelerator is located (logically) in a path between the server and the client. It is transparent to the client and may be configured as a proxy server. One such accelerator currently on the market utilizes a technology sometimes referred to as flash forward object acceleration. Flash forward object acceleration helps to mitigate network delays associated with embedded Web objects such as images, style sheets, or JavaScript files, for example.

Consider a Web page, where parts of the Web page may be dynamically changing. For these dynamic portions of a Web page, the Web page designer may embed objects that refer to a source Uniform Resource Locator (URL) Web address. When that page is requested by a client, such as a browser, the client will download the page. To access the embedded objects, the client will go to the particular URL listed as its source. In this way, if the content needs to be changed quickly or often, it can be done so without changing the entire Web page, because only the content at the source URL needs to be changed. An accelerator using flash forward technology may speed up this process, as described below.

Assume that the accelerator has just been installed so that its cache is completely empty. When a client requests a URL, such as a HyperText Markup Language (HTML) page, the accelerator proxies the request to the origin server, and the origin server delivers the requested HTML page to the accelerator. The accelerator retrieves the HTML page, parses through the HTML page looking for references to embedded objects, and checks to see if the references to these objects are currently cached locally. If the accelerator has just been installed, none of the embedded objects referenced in the HTML page are yet cached in the accelerator's cache. Accordingly, the accelerator delivers the HTML page, as is, to the client. When the client receives this HTML page, it parses through the HTML page looking for references to embedded objects and then requests those embedded objects directly from the origin server via a HTTP (HyperText Transfer Protocol) Get Request command. Because the accelerator is a proxy server, the HTTP Get Request will be passed through the accelerator to the origin server and the subsequent object responses from the origin server will be passed through the accelerator to the client. The client will then cache all cacheable objects, thereby priming its cache. The client browser retrieves and caches the original objects referenced in the HTML page as delivered by the origin server.

Now suppose there is a new browser session and the client requests the same URL. In this case, the accelerator proxies the request to the origin server, and the origin server creates and delivers the requested HTML page to the accelerator. The accelerator parses through the HTML page looking for references to embedded objects, and checks to see if the referenced objects are cached locally. If they are cached locally, the accelerator checks to see if the cached objects can be flash forwarded. In this case, if the objects are both cacheable and can be flash forwarded, the accelerator issues an HTTP IMS (If-Modified-Since) request to the origin server to determine whether or not the cached objects are still valid. If they are valid, then the accelerator renames the already cached object by adding a version to the object name and adding a long-lived-expires HTTP response header to it. This is the flash forward transformation.

The accelerator next rewrites the HTML page delivered by the origin server so that the embedded object references, e.g., URLs, point to the new flash forward transformed names. That is, the flash forward transformed names now represent the requested objects in the accelerator cache rather than the original objects on the origin server. The client browser retrieves the rewritten HTML page and parses through it looking for references to embedded objects. These references now point to the flash forwarded objects cached in the accelerator. The client requests the flash forwarded objects from the accelerator and the accelerator delivers these objects to the client. The client retrieves and caches these objects.

Now, suppose a new browser session begins again and the client requests the same URL. The accelerator proxies the request to the origin server which then creates and delivers the HTML page to the accelerator. Again, the accelerator parses through the HTML page looking for references to embedded objects and checks to see if the referenced objects are cached locally. If so, the accelerator checks to see if the cached objects can be flash forwarded. In this case, if the objects are both cacheable and can be flash forwarded, the accelerator issues an HTTP IMS request to the origin server to determine whether or not the cached objects are still valid. If they are still valid and not modified, then the accelerator knows that the already renamed flash forwarded object is currently in its cache and still valid. Thus, if the object did not change, the object name would be the same, and when this is received by the browser, the browser need only access the client's local cache to retrieve the embedded object. In this way, flash forwarding speeds up delivery of Web content.

If, however, the object did change since last requested, then the accelerator creates a new URL, caches the object, and sends the object to the client, whereby the client, instead of referring to its local cache for the embedded object, will retrieve the modified version at the newly created URL address. That is, because of the expires header added to the embedded objects within the browser cache, the browser will now issue HTTP Get Requests only for those objects referenced in the HTML page that are not already cached in the browser. No HTTP Get Request commands will be issued for any of the flash forwarded objects already cached; they are known to still be fresh because they have a long-lived expires date. In this fashion, flash forward technology enables an accelerator to determine embedded object freshness on the fly and to explicitly communicate this information to the client, so that the client need not need waste valuable time and bandwidth issuing requests to validate object freshness. This accelerates Web page downloading.

The above-described process speeds up content delivery when embedded objects having a source URL are inserted into a Web page. However, this process does not speed up the delivery of those portions of a Web page which have not been so coded. That is, there may be many blocks of static code in a Web page which are downloaded to a client because embedded objects representing those static blocks of code were not employed. In such cases, an accelerator may not know that such static blocks of code should be cached.

### BRIEF DESCRIPTION OF THE DRAWINGS

FIG. 1 illustrates the logical connection of an accelerator between the content servers and clients.

FIG. 2 is a simplified high level architecture of an embodiment of the present invention.

FIG. 3 is a flow diagram illustrating part of the process of an embodiment of the present invention.

FIG. 4 shows a diagrammatic representation of a computer system to implement an embodiment of the present invention.

### DESCRIPTION OF EMBODIMENTS

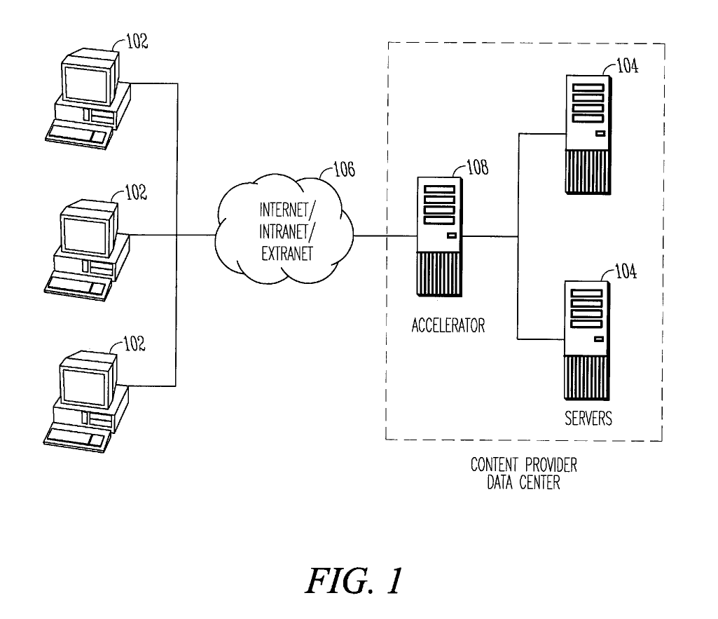

Example embodiments are utilized in an accelerator, or network appliance, which may be located logically in the path from a content origin server, or servers, to a client, such as a browser. This is shown in simple fashion in FIG. 1. In FIG. 1, computers run client software such as browsers, referenced as 102. These clients communicate to servers 104 via an Internet or intranet 106. Transparent to the clients is accelerator 108, which in this example is logically configured as a proxy server. In FIG. 1, the accelerator is shown as a separate box. However, in practice the accelerator may be a card with associated electronics proximate to the server hardware itself.

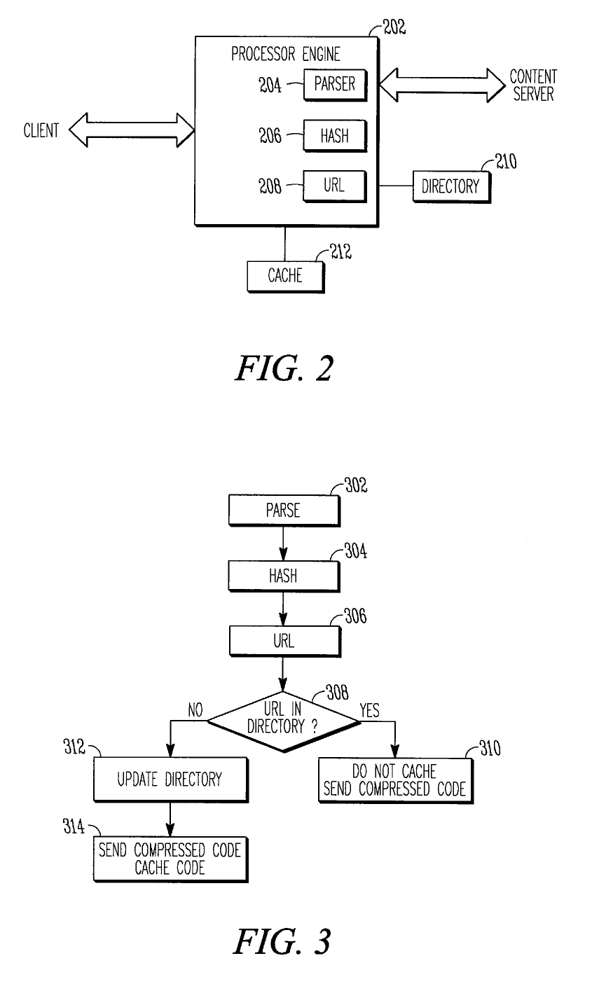

Example embodiments may be illustrated by considering the high level architecture as shown in FIG. 2. In FIG. 2, processor engine 202 may be, for example, a microprocessor, a set of dice (chips), or a portion of a die, to perform various functions. One of the functions performed by processor engine 202 is a parser function, indicated by module 204. In practice, this module is usually a software module running on processor engine 202.

When a client sends a request to the content server, that request is passed from the accelerator to the content server. The content server, in response to that request, sends to the accelerator the requested content, such as a Web page. This requested content may comprise various blocks of code or instructions. Parser 204 will parse the code to determine blocks of code which are not currently coded as embedded objects having their own source URL. In other words, the designer of the Web page may have included one or more blocks of code which are believed to be relatively static, so that the one or more blocks of code are not embedded objects having their own source URL addresses.

In prior art accelerators, such blocks of code that are not embedded objects would not be compressed by a flash forwarding scheme, but would be passed directly to the client as is. However, for the example embodiment as depicted in the architecture of FIG. 2, parser 204 will identify such blocks of code. Hash module 206 performs a hash function upon each such block of code in order to derive a unique URL for each particular block of code. The generation of the URLs is indicated by module 208. Again, modules 206 and 208 may in practice be implemented in software running on processor engine 202. An example of a hash function that may be used to generate a unique URL for a block of code is Message-Digest Algorithm 5 (MD5). See the Internet Engineering Task Force, www.ietf.org/rfc/rfc1321.txt.

When a source URL is generated from a block of code, directory 210 is consulted to determine whether the source URL is in directory 210. If the block of code has already been cached, then the generated source URL will already be in directory 210. If the block of code from which the source URL was generated has not been seen before by the accelerator, then the generated source URL will not be found in directory 210, and the accelerator caches this block of code in cache 212. The accelerator replaces this block of code by a compressed version with a source address given by the newly generated URL and a long-lived expire header, and this compressed code is then sent to the client.

If, however, after performing the hash function indicated by hash module 206 on a block of code, the generated URL is found in directory 210, then this particular block of code has been seen before and it already resides in local cache 212. As before, the compressed version with the generated URL source code and the long-lived expire header is then sent to the client.

Now suppose that when the client receives this compressed code, it finds that the generated source URL is not in its local cache. It will then send an HTTP Get Request to the address given by the generated source URL. This will be received by the accelerator, in which case the block of code is in the accelerator's local cache 212, and this block of code is sent to the client. Now suppose, however, that when the client receives the compressed code from the accelerator that it finds that the URL is in its local cache and that it has not yet expired. That is, the cached code is relevant. Then, the client may retrieve the desired block of code from its own cache. In this fashion, there is a speed up in the process of rendering content because the client need not send an HTTP Get Request to retrieve this block of code from the content server.

Suppose that in another browser session the client sends a request to the same content server, but now a block of the code that was parsed out by parser 204 has changed since the last time that it was requested. In this case, it is desirable that the client should not use the corresponding block of code in its local cache because that is not fresh. The parser as before will go through the code, e.g., requested Web page, looking for blocks of code identified by tags, and then will perform a hash function on each identified block of code. For a parsed block of code that has changed, the hash function will now produce an entirely different URL, even if merely one character in the block of code has changed. When that URL is checked with those stored in directory 210, it will be found that it is not present in directory 210, in which case the accelerator will store the parsed block of code in this local cache and send a compressed version of the block of code to the client with the newly generated URL.

When the client receives the compressed code, it will find it that the newly generated URL is not in its local cache and therefore it will send an HTTP Get Request to the server to obtain the desired block of code. This request will be received by the accelerator, in which case the block of code is read from its cache and sent to the client. The sent block of code will be stored in the client's local cache referenced to that new URL.

Suppose that in another browser session the client sends a request to the same content server, and suppose the block of code has not been changed. Then as discussed before, parser 204 will go through that block of code, the hash function will be performed, and a URL will be generated which already exists in directory 210, in which case the block of code is in the accelerator's local cache 210. The accelerator will send the compressed code to the client, but now the client has already stored that block of code in its own cache referenced to that generated URL, and therefore it will not send an HTTP Get Request because the block of code is fresh and in its local cache.

In this way, content delivery is provided in an efficient manner, and freshness of the cached blocks of code is maintained.

The above described process or method may be viewed as the flow diagram indicated in FIG. 3. In block 302, parsing is performed on the code to find those blocks of code that are not embedded objects. These distinct code blocks may be identified by inserting tags in the code. The hash function indicated by 304 is performed to generate a URL as indicated in 306. In block 308, a decision is made whether that newly generated URL is in a directory or not. If that URL exists in a directory, then in block 310 we see that no caching is required and the compressed code is sent to the client. If, however, the URL is not in the directory, then as indicated in block 312 the directory is updated, and then in block 314 that parsed code block is stored in the cache and the compressed code with the generated URL source is sent to the client.

The process as described above is transparent to the client. The client receives compressed code indicating a source URL. The client will look to see if that source URL is already in its local cache, and if so, it has stored in its cache the block of code associated with the source URL. The client can retrieve the block of code and render the page or content that was requested. The client will also look at the expiration in the header to make sure that it is still fresh. If, however, the source URL does not correspond to an entry in the client's local cache, then the client will send an HTTP Get Request to the URL source address, in which case it will receive fresh content. The client does not know whether this compressed code was done by the content server or an accelerator.

Instructions for implementing embodiments of the present invention may reside on various processor readable media, such as system memory, on-chip memory, or other types of media, such as a storage device.

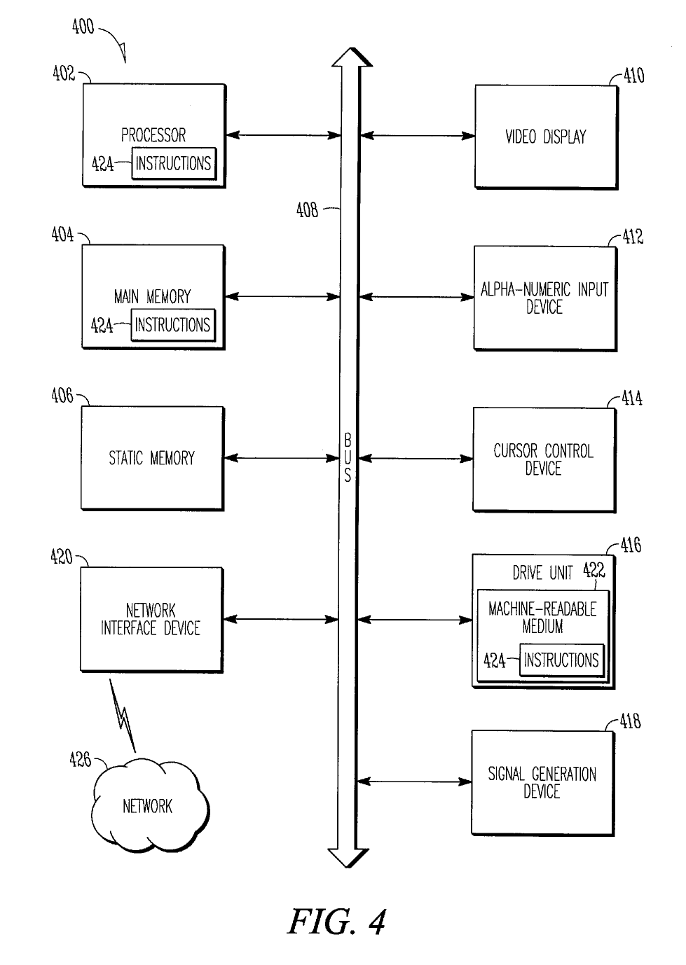

FIG. 4 shows a diagrammatic representation of machine in the exemplary form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420 utilizing any one of a number of well-known transfer protocols (e.g., HTTP).

While the machine-readable medium 422 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

What is claimed is:

1. A computer readable medium comprising instructions which, when executed by a machine, cause the machine to:
parse code to identify a block of code not coded as an embedded object;
perform a hash function on the parsed block of code to derive a source address; and
determine whether the source address is currently stored in a directory.

2. The computer readable medium as set forth in claim 1, wherein the computer readable medium further comprises instructions to:
store the parsed block of code in a cache if the source address is not currently stored in the directory.

3. The computer readable medium as set forth in claim 2, wherein the computer readable medium further comprises instructions to:
compress the parsed block of code into a compressed block of code having the source address; and
send the compressed block of code to a client.

4. The computer readable medium as set forth in claim 3, wherein the computer readable medium further comprises instructions to:
add a long-lived expire header to the compressed block of code.

5. The computer readable medium as set forth in claim 4, wherein the computer readable medium further comprises instructions to send a cached block of code to the client in response to a Get Request command from client having a source address corresponding to the cached block of code.

6. The computer readable medium as set forth in claim 1, wherein the computer readable medium further comprises instructions to send a cached block of code to a client in response to a Get Request command from client having a source address corresponding to the cached block of code.

7. The computer readable medium as set forth in claim 2, wherein the computer readable medium further comprises instructions to send a cached block of code to a client in response to a Get Request command from client having a source address corresponding to the cached block of code.

8. The computer readable medium as set forth in claim 3, wherein the computer readable medium further comprises instructions to send a cached block of code to the client in response to a Get Request command from client having a source address corresponding to the cached block of code.

9. An apparatus comprising:
at least one processor to parse code to identify a block of code not coded as an embedded object, and to perform a hash function on the parsed block of code to derive a source address; and
a directory, the at least one processor to determine whether the source address is currently stored in a directory.

10. The apparatus as set forth in claim 9, further comprising:
a cache, wherein the at least one processor is operable to store the parsed block of code in the cache if the source address is not currently stored in the directory.

11. The apparatus as set forth in claim 10, the at least one processor is operable to compress the parsed block of code into a compressed block of code having the source address, and to send the compressed block of code.

12. The apparatus as set forth in claim 11, the at least one processor is operable to add a long-lived expire header to the compressed block of code.

13. The apparatus as set forth in claim 12, wherein the at least one processor is operable to send a cached block of code in response to a Get Request command having a source address corresponding to the cached block of code.

14. The apparatus as set forth in claim 10, wherein the at least one processor is operable to send a cached block of code in response to a Get Request command having a source address corresponding to the cached block of code.

15. The apparatus as set forth in claim 11, wherein the at least one processor is operable to send a cached block of code in response to a Get Request command having a source address corresponding to the cached block of code.

16. The apparatus as set forth in claim 12, wherein the at least one processor is operable to send a cached block of code in response to a Get Request command having a source address corresponding to the cached block of code.

17. An apparatus comprising:
means for parsing code to identify a block of code not coded as an embedded object;
means for performing a hash function on the parsed block of code to derive a source address; and
means for determining whether the source address is currently stored in a directory.

18. The apparatus as set forth in claim 17, further comprising:
means for storing the parsed block of code in a cache if the source address is not currently stored in the directory.

19. The apparatus as set forth in claim 18, wherein the at least one processor compresses the parsed block of code into a compressed block of code having the source address, and sends the compressed block of code to a client.
